(19) United States
(12) Patent Application Publication
(10) Pub. No.: US 2024/0273851 A1
(43) Pub. Date: Aug. 15, 2024

(54) METHODS AND APPARATUS FOR TILE-BASED STITCHING AND ENCODING OF IMAGES

(71) Applicant: Intel Corporation, Santa Clara, CA (US)

(72) Inventors: Changliang Wang, Bellevue, WA (US); Juan Zhao, Shanghai (CN); Gang Shen, Hillsboro, OR (US); Wei Zong, Beijing (CN)

(21) Appl. No.: 18/569,570

(22) PCT Filed: Nov. 25, 2021
(86) PCT No.: PCT/CN2021/133050

§ 371 Date: Dec. 12, 2023

(51) Int. Cl. G06V 10/10; G06T 5/50; G06T 7/11; G06T 9/00

(52) U.S. Cl. CPC G06V 10/16; G06T 5/50; G06T 7/11; G06T 9/00; G06T 2207/20221

(57) ABSTRACT

Methods and apparatus for tile-based stitching and encoding of images are disclosed. An example apparatus to stitch and encode images includes tile generation circuitry to generate first input tiles from a first image and second input tiles from a second image, the first image from a first camera and the second image from a second camera. The example apparatus also includes stitching circuitry to process the first input tiles and the second input tiles to convert the first input tiles into corresponding first stitched tiles and to convert the second input tiles into corresponding second stitched tiles. The example apparatus further includes encoding circuitry to encode the first stitched tiles and the second stitched tiles in parallel, wherein the tile generation circuitry is to generate the first input tiles and the second input tiles based on division information associated with the encoding circuitry.

### FIELD OF THE DISCLOSURE

This disclosure relates generally to image processing and, more particularly, to methods and apparatus for tile-based stitching and encoding of images.

### BACKGROUND

Many virtual reality (VR) and/or augmented reality (AR) applications utilize image data from a 360-degree scene. One or more cameras capture images corresponding to different portions of the 360-degree scene, and the images are processed and/or stitched together to form a full image of the 360-degree scene. The full image is encoded to enable efficient storage thereof. Additionally or alternatively, the full image is transmitted to a client device (e.g., a head-mounted display (HMD), a VR headset, etc.), and the full image, or a selected field of view in the full image, is decoded and displayed by the client device.

### BRIEF DESCRIPTION OF THE DRAWINGS

FIG. 1 is a schematic illustration of an example system for capturing omnidirectional image data, where the system implements example image processing circuitry in accordance with teachings of this disclosure.

FIG. 2 is a process flow diagram illustrating an example tile-based stitching and encoding process in accordance with teachings of this disclosure.

FIG. 3 is a block diagram of the example image processing circuitry of FIG. 1.

FIG. 4 is an example process flow diagram illustrating an example encoding and decoding process.

FIG. 5A illustrates a first, baseline example image processing pipeline for processing the fisheye images of FIGS. 1 and/or 2.

FIG. 5B illustrates a second, tile-based example image processing pipeline for processing the fisheye images of FIGS. 1 and/or 2.

FIG. 6A is a process flow diagram illustrating a first stitching and encoding process that may be executed by the example stitcher and the example encoder of FIG. 5A.

FIG. 6B is a process flow diagram illustrating a second stitching and encoding process that may be executed by the example image processing circuitry FIG. 3.

FIG. 7 illustrates example tile divisions that may be generated by the example image processing circuitry of FIG. 3.

FIG. 8 illustrates the first example fisheye image and the corresponding first example input image of FIGS. 1 and/or 2.

FIG. 9 illustrates first, second, and third example fisheye images of FIGS. 1 and/or 2.

FIG. 10 illustrates first, second, and third example input images corresponding to the first, second, and third fisheye images, respectively, of FIG. 9.

FIG. 11 illustrates an example stitched image based on the first, second, and third example input images of FIG. 9.

FIG. 12 is a flowchart representative of example machine readable instructions that may be executed by example processor circuitry to implement the example image processing circuitry of FIG. 3.

FIG. 13 is a block diagram of an example processing platform including processor circuitry structured to execute the example machine readable instructions of FIG. 12 to implement the example image processing circuitry of FIG. 3.

FIG. 14 is a block diagram of an example implementation of the processor circuitry of FIG. 13.

FIG. 15 is a block diagram of another example implementation of the processor circuitry of FIG. 13.

FIG. 16 is a block diagram of an example software distribution platform (e.g., one or more servers) to distribute software (e.g., software corresponding to the example machine readable instructions of FIG. 12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time +/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

For some immersive media applications, including those implementing augmented reality (AR) and/or virtual reality (VR), image data representing a scene (e.g., a 360-degree scene) may be generated by combining images from multiple camera perspectives. For example, such image data can be displayed by a VR display device, such as a head-mounted display (HMD), to provide an immersive VR experience for the user. In some examples, the user can adjust an orientation of his or her head to change a field-of-view (FOV) of the VR display device. The FOV of a VR display device describes how extensive an image appears to a user, measured in degrees as observed by one eye (for a monocular VR device) or both eyes (for a binocular VR device). The user can view different portions of the 360-degree scene by moving his or her head and, thus, adjusting the FOV.

To gather the image data of the 360-degree scene, an omnidirectional camera device can capture images and/or videos from multiple perspectives. The omnidirectional camera device can include multiple cameras positioned around a circumference of the device, where each of the cameras captures images corresponding to a different portion of the scene. The images from the multiple cameras can be stitched and/or combined to form a single stitched image corresponding to the entirety of the 360-degree scene. The VR display device can display a portion or all of the stitched image to the user.

In some cases, a resolution of the stitched image is relatively high (e.g., 8,000 pixels (8K) or higher). As such, the stitched image is encoded and/or otherwise compressed to enable efficient transmission and/or storage thereof. In some prior stitching and encoding processes, stitching circuitry, pre-processing circuitry, and encoding circuitry are implemented in separate hardware and/or software. In some cases, the stitching circuitry generates the stitched image and provides a copy of the stitched image to the pre-processing circuitry. The pre-processing circuitry pre-processes the stitched image prior to encoding, where such pre-processing includes dividing the stitched image into multiple tiles (e.g., sub-blocks). The encoding circuitry can encode, in separate processor cores, ones of the tiles in parallel to improve speed and/or efficiency of encoding.

In some prior stitching and encoding processes, a portion or all of the stitched image is copied from the stitching circuitry to the pre-processing circuitry. Copying and/or conversion of the stitched image increases latency and/or the amount of memory utilized by the stitching and encoding processes. Furthermore, in some prior stitching and encoding processes, the tiles are generated at the pre-processing circuitry based on processing capabilities of the encoding circuitry. However, the stitching process is separate and independent from the encoding process and, as such, the stitching process is not aligned on the same tiles utilized in the encoding process. As such, advantages of parallelism based on tile generation are not typically found in such prior stitching processes.

Examples disclosed herein enable external tile generation for a stitching and encoding process pipeline. In examples disclosed herein, example processor circuitry obtains images captured by one or more cameras. For example, the processor circuitry obtains a first image from a first camera and a second image from a second camera, where the first and second images are in fisheye format and correspond to different portions of a scene. In some examples, the processor circuitry generates first input tiles from the first image and second input tiles from the second image, where dimensions of the first and second input tiles are based on requirements associated with the encoding process. The processor circuitry includes stitching circuitry to convert the first and second input tiles into corresponding first and second stitched tiles, where the first and second stitched tiles form a stitched image (e.g., a full image). In some examples, the stitching circuitry provides the first and second stitched tiles to encoding circuitry of the processor circuitry in isolated memory blocks, and the encoding circuitry encodes ones of the first and second stitched tiles in separate processor cores. In examples disclosed herein, the same tile divisions are used in both of the stitching and encoding processes, thus yielding efficiency of parallel processing across multiple cores.

Advantageously, by utilizing tiles across both of the stitching and encoding processes, examples disclosed herein reduce inefficiency and latency relative to prior techniques by eliminating the need for copying the full (e.g., stitched) image between the stitching and encoding processes. Furthermore, memory blocks for storing the tiles can be reused between the stitching and encoding processes, thus reducing the need for pre-processing and preparing of the memory blocks therebetween. By generating the tiles that are compatible with both the stitching and encoding processes, examples disclosed herein improve processing speed by enabling parallel processing across multiple cores.

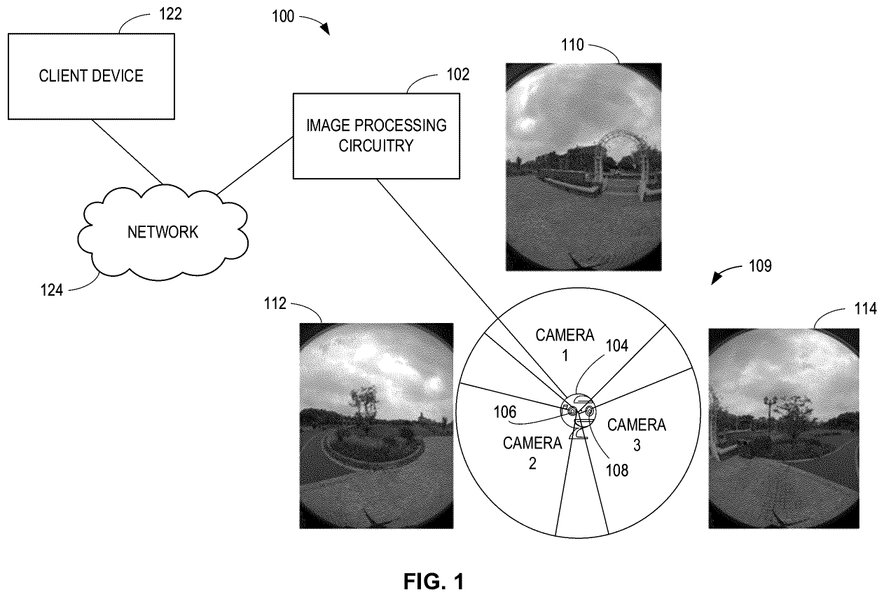

FIG. 1 is a schematic illustration of an example system 100 for capturing omnidirectional image data, where the system 100 implements example image processing circuitry 102 in accordance with teachings of this disclosure. In the illustrated example of FIG. 1, the system 100 includes a first example camera 104, a second example camera 106, and a third example camera 108. In this example, the first, second, and third cameras 104, 106, 108 are implemented on a single device (e.g., an omnidirectional camera device) 109. In other examples, the first, second, and third cameras 104, 106, 108 are implemented on separate devices. In this example, the first, second, and third cameras 104, 106, 108 are fisheye cameras that capture images in a fisheye format. However, in other examples, a different camera type, or combinations of camera types, can be used.

In the illustrated example of FIG. 1, the first camera 104 captures a first example fisheye image 110, the second camera 106 captures a second example fisheye image 112, and the third camera 108 captures a third example fisheye image 114. In this example, the first fisheye image 110 corresponds to a first portion of a scene, the second fisheye image 112 corresponds to a second portion of the scene, and the third fisheye image 114 corresponds to a third portion of the scene, where the scene is a 360-degree scene surrounding the omnidirectional camera 109. In this example, each of the first, second, and third fisheye images 110, 112, 114 corresponds to greater than 120 degrees of the 360-degree scene. Furthermore, in this example, the first, second, and third fisheye images 110, 112, 114 include overlapping and/or repeating portions.

In the illustrated example of FIG. 1, the image processing circuitry 102 is communicatively coupled to the first, second, and third cameras 104, 106, 108 to obtain the first, second, and third fisheye images 110, 112, 114 therefrom. In this example, the image processing circuitry 102 can stitch and/or otherwise combine the first, second, and third fisheye images 110, 112, 114 to generate a stitched image (e.g., a full image) representing the 360-degree scene surrounding the omnidirectional camera 109. In some examples, a resolution of the stitched video is relatively high (e.g., 8000 pixels). As such, to efficiently store and/or transmit the stitched image, the image processing circuitry 102 encodes the stitched image. In some such examples, the image processing circuitry 102 divides the stitched image into tiles (e.g., sub-blocks, sub-images, image portions) and provides the tiles to separate processor cores for encoding. In some examples, division of the stitched image into tiles enables parallel processing and/or encoding of the tiles with the separate processor cores, thus reducing latency in the storage and/or transmission of the stitched image.

In the illustrated example of FIG. 1, the image processing circuitry 102 is communicatively coupled to an example client device 122 via an example network 124. In some examples, the client device 122 is a virtual reality (VR) headset that can display different portions of the stitched image based on orientations of a user of the client device 122. For example, the user can adjust the orientation of his or her head to adjust a field of view (FOV) of the client device 122, and the displayed portion of the stitched image can change based on the FOV. In some examples, the image processing circuitry 102 obtains information from the client device 122 indicating the FOV of the client device 122.

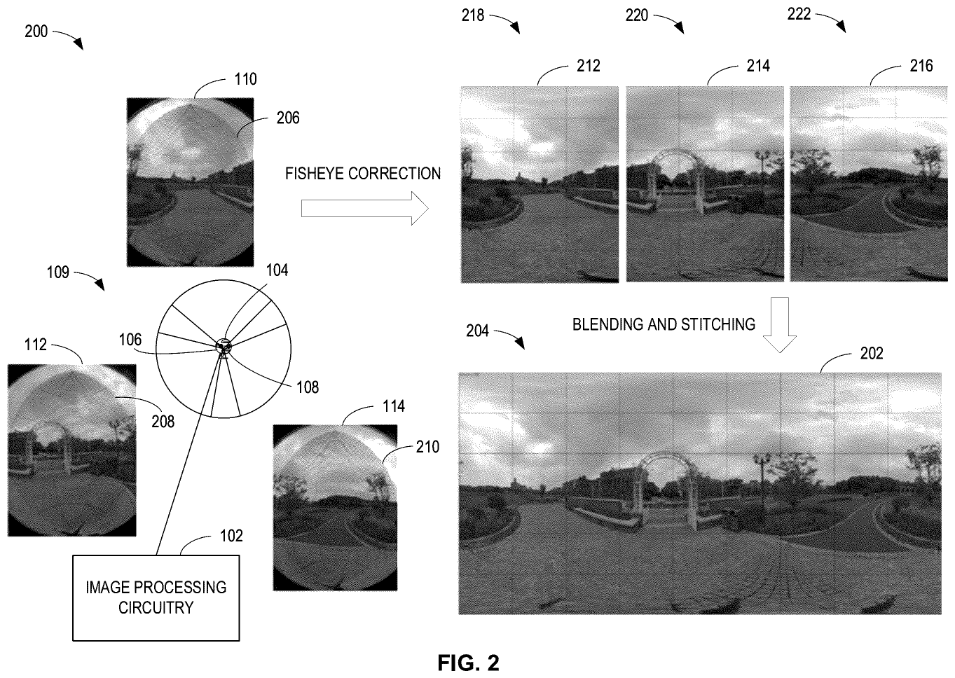

FIG. 2 is a process flow diagram illustrating an example tile-based stitching and encoding process 200 implemented by the example image processing circuitry 102 in accordance with teachings of this disclosure. In the illustrated example of FIG. 2, the image processing circuitry 102 obtains the first, second, and third fisheye images 110, 112, 114 from the first, second, and third cameras 104, 106, 108, respectively.

In this example, the image processing circuitry 102 determines division information based on processing capabilities and/or requirements associated with an encoding process. For example, the image processing circuitry 102 determines the division information based on a number and/or bandwidth of processor cores used in the encoding process. In some examples, the division information identifies sizes and/or locations (e.g., pixel boundaries) of example stitched tiles 202 for dividing an example stitched image 204. In some examples, the division information identifies the sizes and/or locations in a rectangular format, and the image processing circuitry 102 maps and/or converts the division information between the rectangular format and the fisheye format based on one or more equations (e.g., mapping functions).

In this example, based on the converted division information in the fisheye format, the image processing circuitry 102 generates example first blocks (e.g., first sub-blocks) 206 from the first fisheye image 110, example second blocks (e.g., second sub-blocks) 208 from the second fisheye image 112, and example third blocks (e.g., third sub-blocks) 210 from the third fisheye image 114. In this example, the blocks 206, 208, 210 are in fisheye format and are projected onto corresponding ones of the fisheye images 110, 112, 114.

In the illustrated example of FIG. 2, the image processing circuitry 102 performs fisheye correction (e.g., image distortion correction) on the first, second, and third blocks 206, 208, 210 to generate corresponding example first, second, and third input tiles 212, 214, 216, where the input tiles 212, 214, 216 are in rectangular format. In some examples, fisheye correction is used to transform an image from fisheye format to rectangular format to remove and/or otherwise reduce distortion of the image. In some examples, fisheye correction can be performed by mapping, using one or more equations, pixels of the image in the fisheye format to corresponding locations in the rectangular format. In this example, the first input tiles 212 form a first example input image 218, the second input tiles 214 form a second example input image 220, and the third input tiles 216 form a third example input image 222. In this example, the first, second, and third input images 218, 220, 222 are in rectangular format and correspond to the first, second, and third fisheye images 110, 112, 114, respectively.

In the illustrated example of FIG. 2, the image processing circuitry 102 blends and stitches the input tiles 214, 216, 218 to generate the stitched image 204, where the stitched image 204 corresponds to a 360 degree view of the scene captured by the omnidirectional camera 109, or a specified FOV of the 360 degree view of the scene. To store and/or transmit the stitched image 204, the image processing circuitry 102 encodes the stitched image 204 by encoding the stitched tiles 202 in parallel with separate processor cores and/or threads. In this example, the input tiles 214, 216, 218 of the input images 218, 220, 222 correspond to the same tile divisions used for the stitched tiles 202 of the stitched image 204. As such, the stitching and encoding processes can be aligned on the same tile divisions, thus enabling parallel processing of tiles across both of the stitching and encoding processes.

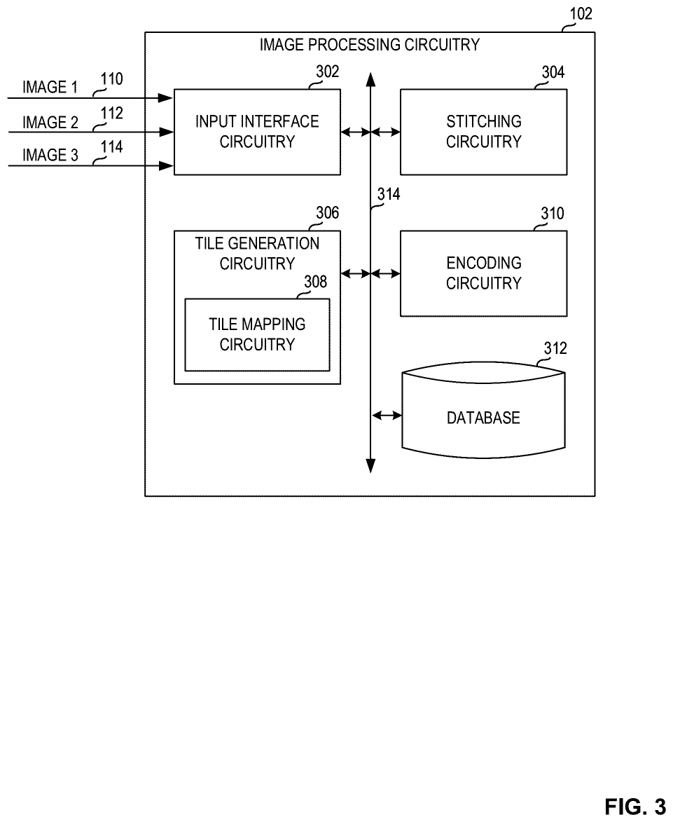

FIG. 3 is a block diagram of the example image processing circuitry 102 of FIGS. 1 and/or 2. In this example, the image processing circuitry 102 is configured to execute the tile-based stitching and encoding process 200 shown in FIG. 2. In the illustrated example of FIG. 3, the image processing circuitry 102 includes example input interface circuitry 302, example stitching circuitry 304, example tile generation circuitry 306 including example tile mapping circuitry 308, example encoding circuitry 310, and an example database 312. In the example of FIG. 2, any of the input interface circuitry 302, the stitching circuitry 304, the tile generation circuitry 306, the tile mapping circuitry 308, the encoding circuitry 310, and/or the database 312 can communicate via an example communication bus 314.

In examples disclosed herein, the communication bus 314 may be implemented using any suitable wired and/or wireless communication. In additional or alternative examples, the communication bus 314 includes software, machine readable instructions, and/or communication protocols by which information is communicated among the input interface circuitry 302, the stitching circuitry 304, the tile generation circuitry 306, the tile mapping circuitry 308, the encoding circuitry 310, and/or the database 312.

In the illustrated example of FIG. 3, the database 312 stores data utilized and/or obtained by the image processing circuitry 102. In some examples, the database 312 stores the fisheye images 110, 112, 114, the input images 218, 220, 222 of FIG. 2, the blocks 206, 208, 210 of FIG. 2, the input tiles 212, 214, 216 of FIG. 2, the stitched tiles 202 of FIG. 2, the stitched image 204 of FIG. 2, and/or division information associated with an encoding process implemented by the encoding circuitry 310. The example database 312 of FIG. 3 is implemented by any memory, storage device and/or storage disc for storing data such as, for example, flash memory, magnetic media, optical media, solid state memory, hard drive(s), thumb drive(s), etc. Furthermore, the data stored in the example database 312 may be in any data format such as, for example, binary data, comma delimited data, tab delimited data, structured query language (SQL) structures, etc. While, in the illustrated example, the example database 312 is illustrated as a single device, the example database 312 and/or any other data storage devices described herein may be implemented by any number and/or type(s) of memories.

In the illustrated example of FIG. 3, the input interface circuitry 302 obtains input data from at least one of the omnidirectional camera 109 and/or the client device 122 of FIG. 1. For example, the input interface circuitry 302 obtains the first, second, and third fisheye images 110, 112, 114 from respective ones of the first, second, and third cameras 104, 106, 108 of FIGS. 1 and/or 2, where the fisheye images 110, 112, 114 correspond to different portions of a 360-degree scene. In some examples, the input interface circuitry 302 obtains, via the network 124 of FIG. 1, FOV information associated with the client device 122. In some examples, the FOV information identifies a portion of the 360 degree-scene that is viewable to a user from a viewport displayed by the client device 122. In some examples, the input interface circuitry 302 provides the fisheye images 110, 112, 114 and/or the FOV information to the database 312 for storage therein.

In the illustrated example of FIG. 3, the tile generation circuitry 306 generates and/or determines tile divisions for generating the blocks 206, 208, 210 and/or the input tiles 212, 214, 216 of FIG. 2. For example, the tile generation circuitry 306 determines the tile divisions, in rectangular format, based on division information associated with the encoding circuitry 310. In some examples, the division information is based on size (e.g., resolution) requirements for an image frame input into the encoding circuitry 310.

Additionally or alternatively, the division information is based on a number of processor cores utilized by the encoding circuitry 310. For example, the division information may indicate that the number of tiles in the tile divisions corresponds to the number of processor cores utilized by the encoding circuitry 310. In some examples, the tile divisions correspond to the stitched tiles 202 in the stitched image 204.

In this example, the tile mapping circuitry 308 maps and/or converts the tile divisions to a fisheye format based on parameters (e.g., intrinsic and/or extrinsic parameters) of the cameras 104, 106, 108. For example, the tile mapping circuitry 308 calculates, based on example Equations 1, 2, 3, 4, 5, and/or 6 below, pixel boundary coordinates that represent the tile divisions in the fisheye format. In some examples, the pixel boundary coordinates correspond to the blocks 206, 208, 210 in the fisheye images 110, 112, 114.

$$\\ \begin{matrix}Pixel\_boundary . x = \frac{- r * x}{\sqrt{{x}^{{}_{} 2} + {z}^{{}_{} 2}}} * cos ( extrinsic . roll ) - \frac{- r * z}{\sqrt{{x}^{{}_{} 2} + {z}^{{}_{} 2}}} * sin ( extrinsic . roll ) + intrinsic . cx & Equation 1\end{matrix}$$

$$\\ \begin{matrix}Pixel\_boundary . y = \frac{- r * x}{\sqrt{{x}^{{}_{} 2} + {z}^{{}_{} 2}}} * sin ( extrinsic . roll ) + \frac{- r * z}{\sqrt{{x}^{{}_{} 2} + {z}^{{}_{} 2}}} * cos ( extrinsic . roll ) + intrinsic . cy & Equation 2\end{matrix}$$

$$\\ \begin{matrix}x = sin β * cos α & Equation 3\end{matrix}$$

$$\\ \begin{matrix}y = sin β * sin α & Equation 4\end{matrix}$$

$$\\ \begin{matrix}z = cos β & Equation 5\end{matrix}$$

$$\\ \begin{matrix}r = \frac{arc cos β * 2 * intrinsic . radius}{intrinsic . fov} & Equation 6\end{matrix}$$

In Equations 1, 2, 3, 4, 5, and/or 6 above, α represents a tile boundary in longitude of the stitched image 204 and β represents the tile boundary in latitude of the stitched image 204, where α is between 0 and 2π (e.g., 0<α<2π) and β is between 0 and π (e.g., 0<β<π). Furthermore, Pixel_boundary.x represents the tile boundary in horizontal pixel coordinates of the fisheye images 110, 112, 114, and Pixel_boundary.y represents the tile boundary in vertical pixel coordinates of the fisheye images 110, 112, 114. In the example Equations 1, 2, 3, 4, 5, and/or 6 above, extrinsic.roll represents an extrinsic parameter associated with a rotation matrix of the omnidirectional camera 109. In this example, intrinsic.cx and intrinsic.cy represent an optical center of a coordinate system of the omnidirectional camera 109, intrinsic.radius represents a radius of the fisheye images 110, and intrinsic.fov represents FOV information associated with the omnidirectional camera 109.

In some examples, in response to the tile mapping circuitry 308 determining the pixel boundary coordinates in the fisheye format, the tile generation circuitry 306 generates the blocks 206, 208, 210 based on the pixel boundary coordinates. For example, the tile generation circuitry 306 divides (or, in other words, segments) the first, second, and third fisheye images 110, 112, 114 into the blocks 206, 208, 210 based on the pixel boundary coordinates. Furthermore, the tile generation circuitry 306 generates the input tiles 212, 214, 216 by performing fisheye correction on corresponding ones of the blocks 206, 208, 210. In some examples, the tile generation circuitry 306 stores the input tiles 212, 214, 216 in respective isolated memory blocks.

In the illustrated example of FIG. 3, the stitching circuitry 304 processes the input tiles 212, 214, 216 to convert the input tiles 212, 214, 216 into the stitched tiles 202 of FIG. 2. For example, the stitching circuitry 304 blends and stitches the input tiles 212, 214, 216 to form the stitched image 204 of FIG. 2, where each of the input tiles 212, 214, 216 corresponds to a corresponding one of the stitched tiles 202. In examples disclosed herein, stitching refers to a process of combining multiple images with overlapping portions to produce a single image. In examples disclosed herein, blending refers to a process of reducing visibility of edges between stitched ones of the multiple images. In some examples, the blending is performed by adjusting intensities of overlapping pixels between the stitched ones of the multiple images.

In some examples, the stitching circuitry 304 processes the input tiles 212, 214, 216 in separate stitching processor cores and/or threads to generate the stitched tiles 202. As a result, the stitching circuitry 304 replaces the input tiles 212, 214, 216 in the respective isolated memory blocks with the stitched tiles 202. In some examples, the stitching circuitry 304 provides the stitched tiles 202 in the isolated memory blocks to the encoding circuitry 310 for further processing.

In the illustrated example of FIG. 3, the encoding circuitry 310 encodes the stitched tiles 202 in separate encoding processor cores of the encoding circuitry 310. In examples disclosed herein, encoding (e.g., image compression) refers to a process of converting an image to a digital format that reduces space required to store the image. In some examples, the encoding reduces a size of an image file of the image while retaining characteristics of the original (e.g., unencoded) image. In this example, the isolated memory blocks that are passed from the stitching circuitry 304 to the encoding circuitry 310 are aligned with the encoding processor cores. As such, the encoding circuitry 310 can provide the stitched tiles 202 from the isolated memory blocks to the separate encoding processor cores, and the encoding circuitry 310 processes and/or encodes the stitched tiles 202 in parallel. In other examples, the stitched tiles 202 are not provided to the separate processor cores of the encoding circuitry 310, and instead may be encoded in the processor cores implemented by the stitching circuitry 304. Stated differently, both stitching and encoding of the input tiles 212, 214, 216 and/or the stitched tiles 202 can be performed in the same processor cores. In some examples, the encoding circuitry 310 can store encoded ones of the stitched tiles 202 in the database 312 and/or can transmit the encoded ones of the stitched tiles 202 to the client device 122 of FIG. 1 via the network 124 of FIG. 1.

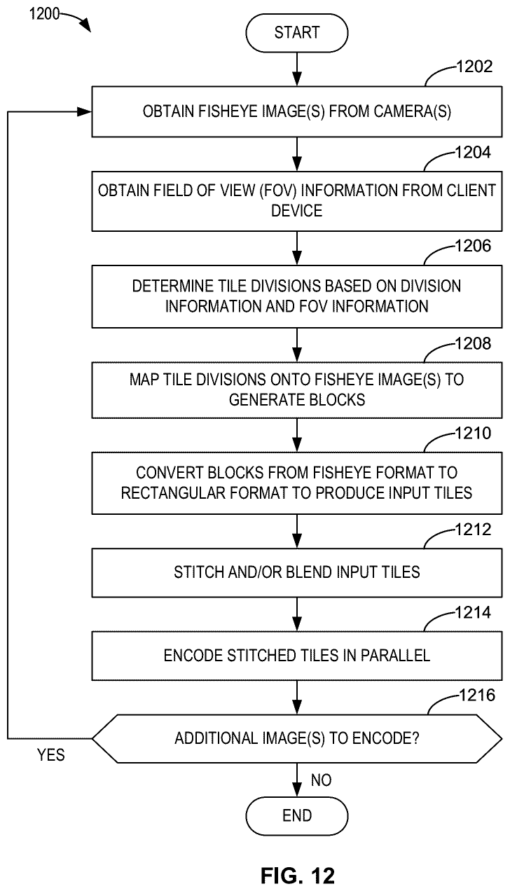

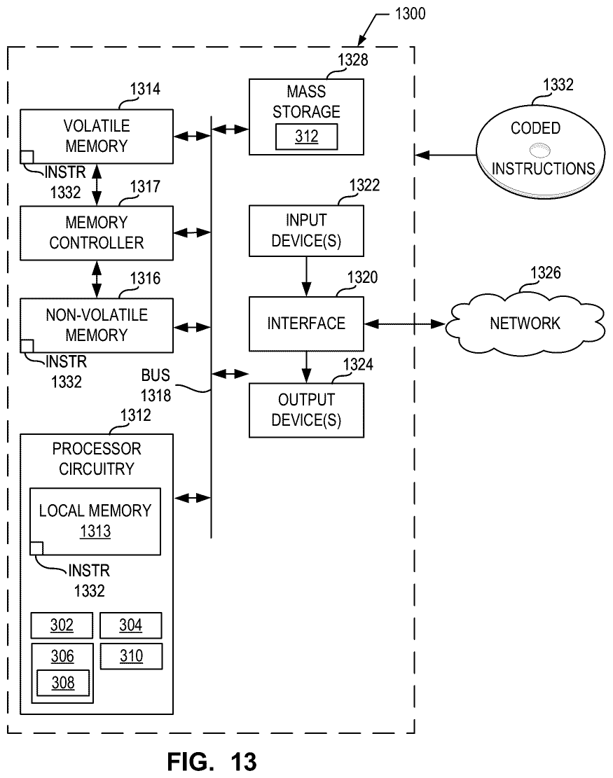

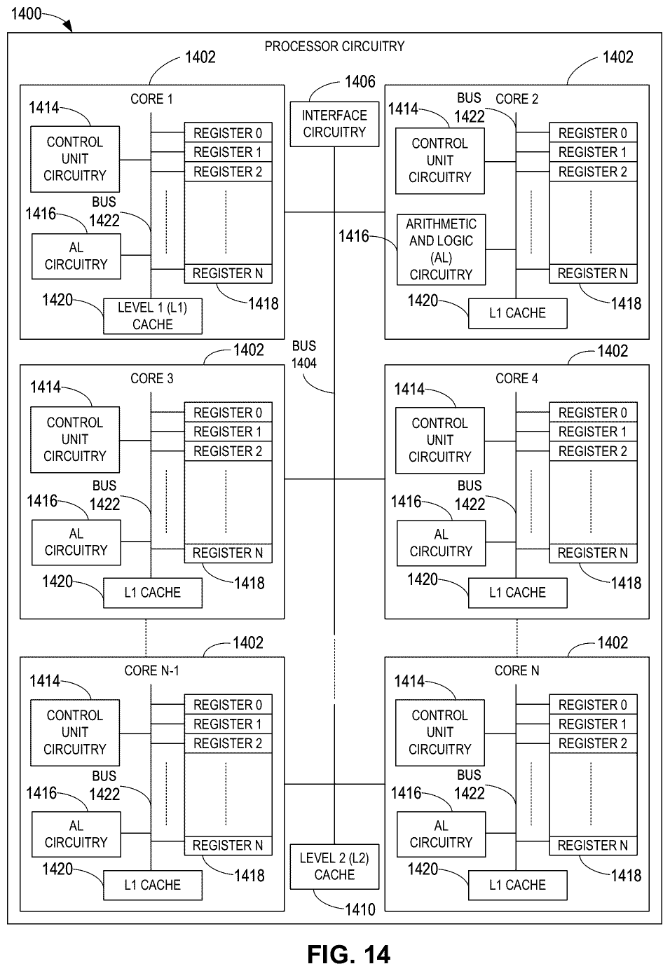

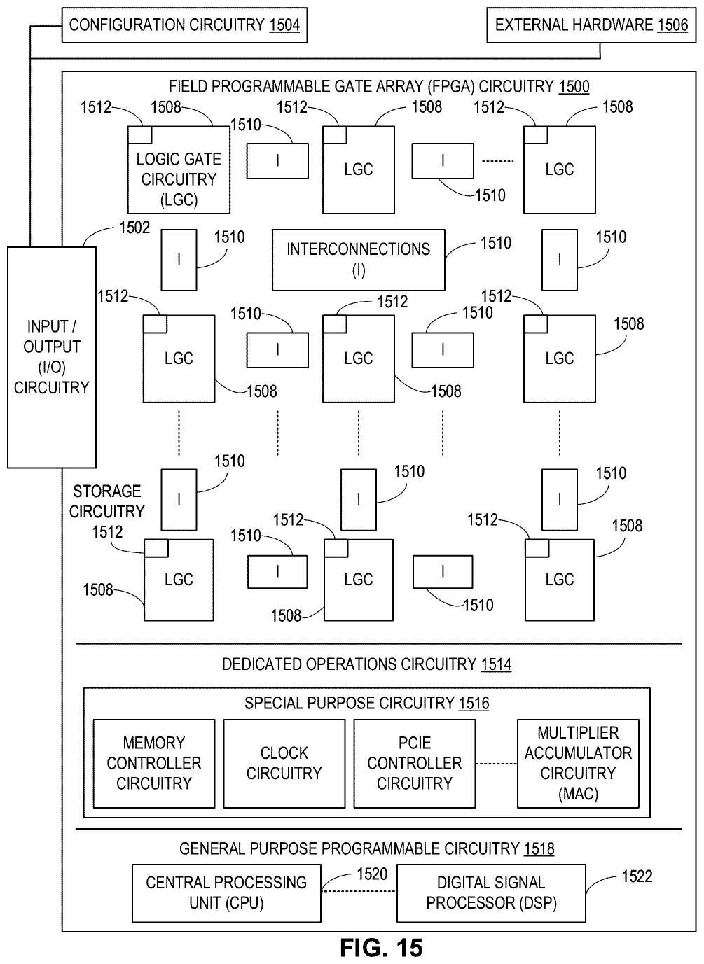

In some examples, the image processing circuitry 102 includes means for obtaining data. For example, the means for obtaining data may be implemented by the input interface circuitry 302. In some examples, the input interface circuitry 302 may be implemented by machine executable instructions such as that implemented by at least blocks 1202, 1204, 1206 of FIG. 12 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the input interface circuitry 302 is implemented by other hardware logic circuitry, hardware implemented state machines, and/or any other combination of hardware, software, and/or firmware. For example, the input interface circuitry 302 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the image processing circuitry 102 includes means for generating tiles. For example, the means for generating tiles may be implemented by the tile generation circuitry 306. In some examples, the tile generation circuitry 306 may be implemented by machine executable instructions such as that implemented by at least blocks 1206, 1210 of FIG. 12 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the tile generation circuitry 306 is implemented by other hardware logic circuitry, hardware implemented state machines, and/or any other combination of hardware, software, and/or firmware. For example, the tile generation circuitry 306 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the means for generating tiles includes means for mapping. For example, the means for mapping may be implemented by the tile mapping circuitry 308. In some examples, the tile mapping circuitry 308 may be implemented by machine executable instructions such as that implemented by at least block 1208 of FIG. 12 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the tile mapping circuitry 308 is implemented by other hardware logic circuitry, hardware implemented state machines, and/or any other combination of hardware, software, and/or firmware. For example, the tile mapping circuitry 308 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the image processing circuitry 102 includes means for stitching. For example, the means for stitching may be implemented by the stitching circuitry 304. In some examples, the stitching circuitry 304 may be implemented by machine executable instructions such as that implemented by at least block 1212 of FIG. 12 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the stitching circuitry 304 is implemented by other hardware logic circuitry, hardware implemented state machines, and/or any other combination of hardware, software, and/or firmware. For example, the stitching circuitry 304 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the image processing circuitry 102 includes means for encoding. For example, the means for encoding may be implemented by the encoding circuitry 310. In some examples, the encoding circuitry 310 may be implemented by machine executable instructions such as that implemented by at least block 1214 of FIG. 12 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the encoding circuitry 310 is implemented by other hardware logic circuitry, hardware implemented state machines, and/or any other combination of hardware, software, and/or firmware. For example, the encoding circuitry 310 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

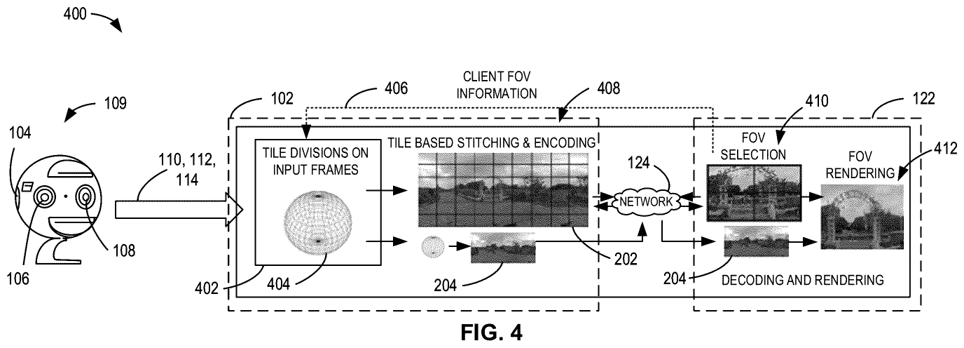

FIG. 4 is an example process flow diagram illustrating an example encoding and decoding process 400. In some examples, the encoding and decoding process 400 of FIG. 4 may be executed by the system 100 of FIG. 1 to process image data to be displayed by the client device 122 of FIG. 1. In the illustrated example of FIG. 4, the cameras 104, 106, 108 of the omnidirectional camera 109 provide the fisheye images 110, 112, 114 for processing to the image processing circuitry 102 of FIGS. 1, 2, and/or 3.

At an example tile generation operation 402 of the encoding and decoding process 400, the image processing circuitry 102 determines example tile divisions 404 based on division information from the encoding circuitry 310 of FIG. 3 and/or example FOV information 406 from the client device 122. In some examples, the image processing circuitry 102 obtains the FOV information 406 from the client device 122 via the network 124, where the FOV information 406 identifies a location and/or orientation of a viewport of the client device 122 relative to the 360-degree scene captured by the omnidirectional camera 109. In some examples, the image processing circuitry 102 can determine the tile divisions 404 such that the tile divisions 404 align with the viewport of the client device 122. For example, boundaries of one or more of the tile divisions 404 may correspond to outer edges of the viewport. In this example, the image processing circuitry 102 maps the tile divisions 404 onto the fisheye images 110, 112, 114 using Equations 1-6 above to generate the blocks 206, 208, 210 of FIG. 2.

At an example tile-based stitching and encoding operation 408 of the encoding and decoding process 400, the image processing circuitry 102 generates the stitched tiles 202 corresponding to the stitched image 204 of FIG. 2. For example, the image processing circuitry 102 performs fisheye correction on the blocks 206, 208, 210 of the fisheye images 110, 112, 114 to generate the input tiles 212, 214, 216 of FIG. 2, and then blends and stitches the input tiles 212, 214, 216 to form the stitched tiles 202 and/or the stitched image 204. Furthermore, the image processing circuitry 102 encodes the stitched tiles 202 in parallel and provides the encoded stitched tiles 202 to the client device 122 via the network 124. In this example, the image processing circuitry 102 can also generate and provide a copy of the stitched image 204 to the client device 122.

In the illustrated example of FIG. 4, the client device 122 obtains the stitched tiles 202 and/or the copy of the stitched image 204 via the network 124. At an example FOV selection operation 410 of the encoding and decoding process 400, the FOV information 406 is generated based on the position and/or orientation of the viewport of the client device 122 relative to the 360-degree scene. In some examples, when the client device 122 is a VR headset, the position and/or orientation of the viewport may change in response to a user of the client device 122 moving his or her head. As such, the client device 122 can periodically update and send the FOV information 406 to the image processing circuitry 102 for use in the tile generation 402. At an example FOV rendering operation 412 of the encoding and decoding process 400, the client device 122 renders the stitched image 204 by decoding the stitched tiles 202 from the image processing circuitry 102. In some examples, the client device 122 displays a rendered portion of the stitched image 204 to the user, where the rendered portion corresponds to the viewpoint selected by the user at the FOV selection operation 410. In some examples, the encoding and decoding process 400 of FIG. 4 may be re-executed by the system 100 of FIG. 1 for one or more additional frames and/or images captured by the omnidirectional camera 109.

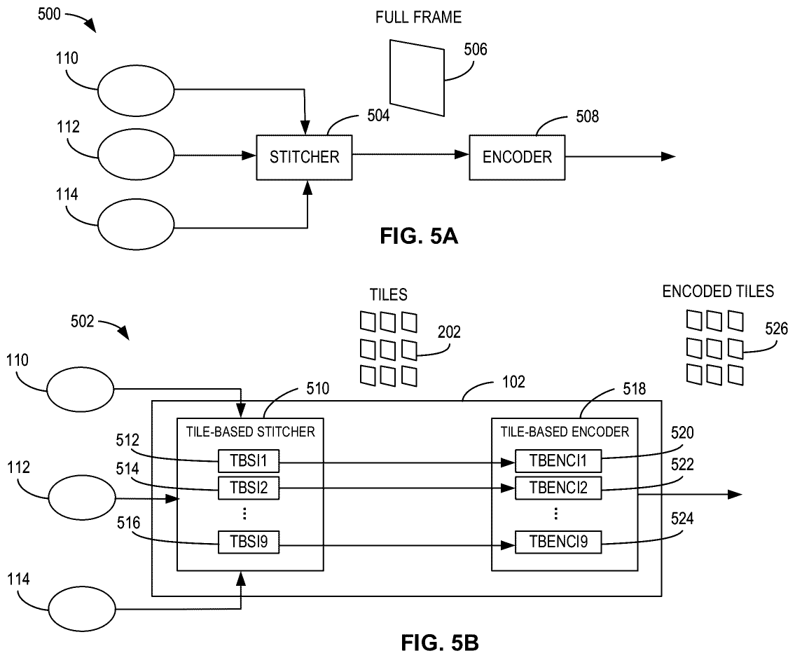

FIG. 5A illustrates a first example baseline image processing pipeline 500 and FIG. 5B illustrates a second example tile-based image processing pipeline 502 for processing the fisheye images 110, 112, 114. In the illustrated example of FIG. 5A, the cameras 104, 106, 108 of FIG. 1 provide the fisheye images 110, 112, 114 to an example baseline stitcher (e.g., baseline stitching circuitry) 504. The baseline stitcher 504 performs fisheye correction and stitches the fisheye images 110, 112, 114 to form an example full frame (e.g., a full image) 506 corresponding to the 360-degree scene. In this example, the baseline stitcher 504 provides the full frame 506 to an example baseline encoder (e.g., baseline encoding circuitry) 508, where the baseline stitcher 504 and the baseline encoder 508 are implemented in separate hardware and/or software. In the example of FIG. 5A, the full frame 506 is not divided into tiles and/or blocks when provided to the encoder 508. Stated differently, an entirety of the full frame 506 and/or a copy of the full frame 506 is passed from the stitcher 504 to the encoder 508. As such, in the baseline image processing pipeline 500, the full frame 506 may require additional pre-processing prior to encoding. For example, the encoder 508 can divide the full frame 506 into tiles and/or blocks to enable parallel processing thereof along multiple processor cores.

Alternatively, in the tile-based image processing pipeline 502 of FIG. 5B, which is implemented in accordance with teachings of this disclosure, the fisheye images 110, 112, 114 are provided to an example tile-based stitcher 510, where the tile-based stitcher 510 corresponds to the stitching circuitry 304 of FIG. 3. In the illustrated example of FIG. 5B, the tile-based stitcher 510 divides the fisheye images 110, 112, 114 based on the tile divisions 404 of FIG. 4 to generate the input tiles 212, 214, 216 of FIG. 2. In this example, the tile-based stitcher 510 processes the input tiles 212, 214, 216 in respective example stitching processor cores 512, 514, 516, where a number of the stitching processor cores 512, 514, 516 corresponds to a number of the input tiles 212, 214, 216. For example, ones of the input tiles 212, 214, 216 are stored in respective isolated memory blocks, and the isolated memory blocks are provided to respective ones of the stitching processor cores 512, 514, 516. In this example, the tile-based stitcher 510 performs parallel processing (e.g., stitching and blending) of the input tiles 212, 214, 216 along the separate stitching processor cores 512, 514, 516 to convert and/or transform the input tiles 212, 214, 216 into respective ones of the stitched tiles 202. During such processing, the tile-based stitcher 510 replaces the input tiles 212, 214, 216 in the isolated memory blocks with corresponding ones of the stitched tiles 202.

In the illustrated example of FIG. 5B, the tile-based stitcher 510 provides the stitched tiles 202 in the isolated memory blocks to an example tile-based encoder 518. In this example, the tile-based encoder 518 corresponds to the encoding circuitry 310 of FIG. 3. In the example of FIG. 4, the stitching processor cores 512, 514, 516 of the tile-based stitcher 510 are aligned with example encoding processor cores 520, 522, 524 of the tile-based encoder 518. In this example, the stitched tiles 202 are transmitted from respective ones of the stitching processor cores 512, 514, 516 to respective ones of the encoding processor cores 520, 522, 524. Stated differently, a first one of the stitched tiles 202 from the first stitching processor core 512 is provided to the respective first encoding processor core 520, a second one of the stitched tiles 202 from the second stitching processor core 514 is provided to the second encoding processor core 522, a third one of the stitched tiles 202 from the third stitching processor core 516 is provided to the third encoding processor core 524, and so on. As such, the tile-based stitcher 510 provides the stitched tiles 202 to the tile-based encoder 518 separately along the isolated memory blocks instead of as a single frame (e.g., the full frame 506 of FIG. 5A).

In the example of FIG. 5B, the tile-based encoder 518 encodes the stitched tiles 202 in parallel across the encoding processor cores 520, 522, 524. As such, the stitched tiles 202 can be encoded at substantially the same time to reduce a total processing time for the encoding process. In response to executing the encoding process across the encoding processor cores 520, 522, 524, the tile-based encoder 518 outputs example encoded tiles 526. In some examples, the encoded tiles 526 are stored in the database 312 of FIG. 3 and/or provided to the client device 122 via the network 124 of FIG. 1.

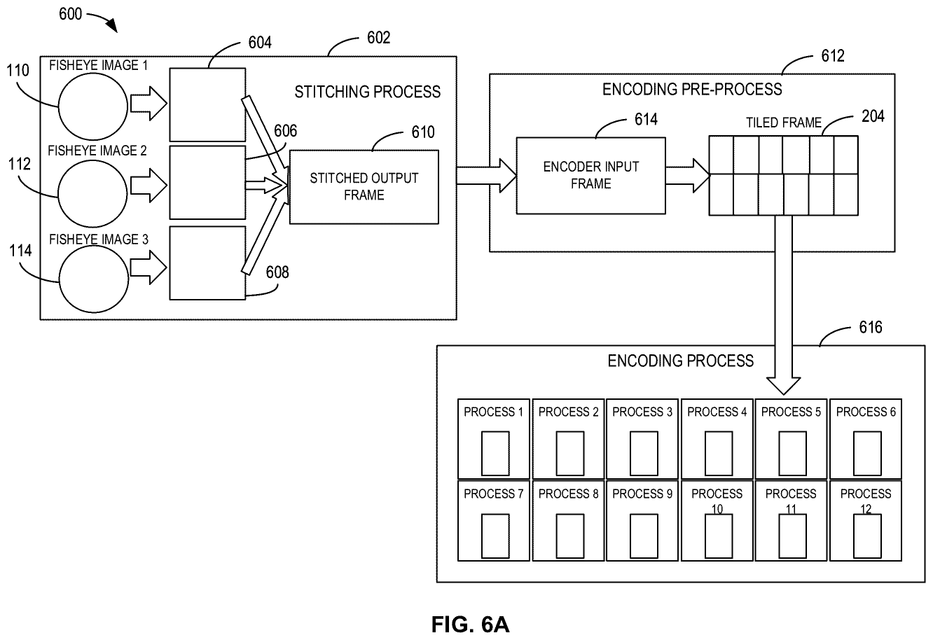

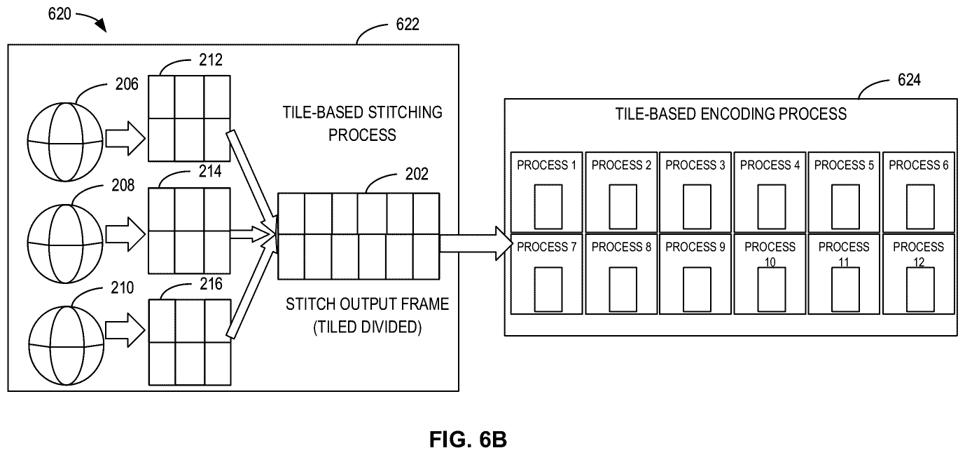

FIG. 6A is a process flow diagram illustrating a first example baseline stitching and encoding process 600 that may be executed by the baseline stitcher 504 and the encoder 508 of FIG. 5A. In the illustrated example of FIG. 5A, at an example baseline stitching process 602 of the baseline stitching and encoding process 600, the baseline stitcher 504 performs fisheye correction of the fisheye images 110, 112, 114 to generate corresponding example fisheye-corrected images 604, 606, 608, where the fisheye-corrected images 604, 606, 608 are in rectangular format. In this example, the fisheye-corrected images 604, 606, 608 are similar to the input images 218, 220, 222 of FIG. 2, but are not divided into the input tiles 212, 214, 216. In the example of FIG. 6A, the baseline stitcher 504 processes (e.g., blends and/or stitches) the fisheye-corrected images 604, 606, 608 to output an example stitched output frame 610, where the stitched output frame 610 is a single image corresponding to a 360-degree scene.

In some examples, parallel encoding of the stitched output frame 610 is desired in order to reduce latency and computation costs. However, the stitched output frame 610 requires additional pre-processing to enable such parallel encoding. As such, in the illustrated example of FIG. 6A, an example baseline encoding pre-process 612 of the baseline stitching and encoding process 600 may be executed in pre-processing circuitry implemented in one of the baseline stitcher 504, the baseline encoder 508, or separate hardware and/or software. In this example, a copy of the stitched output frame 610 is provided to the pre-processing circuitry as an example encoder input frame 614. In some examples, the pre-processing circuitry divides the encoder input frame 614 into the stitched tiles 202 of FIGS. 2, 4, and/or 5B to produce the stitched image 204. In this example, the stitched tiles 202 are provided to separate processor cores of the encoder 508, where the encoder 508 executes an example encoding process 616 by encoding the stitched tiles 202 in parallel. In this example, given the different computational requirements between the stitching and encoding processes 602, 616, parallel processing may be implemented at the encoding process 616 but is not available in the stitching process 602.

FIG. 6B is a process flow diagram illustrating a second example tile-based stitching and encoding process 620 that may be executed by the image processing circuitry 102 of FIG. 3 and/or the tile-based stitcher 510 and the tile-based encoder 518 of FIG. 5B. In the illustrated example of FIG. 6B, the second stitching and encoding process 620 does not including an encoding pre-process, such as the encoding pre-process 612 of FIG. 6A. Instead, the second stitching and encoding process 620 includes an example tile-based stitching process 622 and an example tile-based encoding process 624.

As described in connection with FIG. 3 above, the tile generation circuitry 306 of FIG. 3 generates the blocks 206, 208, 210 from the fisheye images 110, 112, 114 of FIG. 2, and further generates the input tiles 212, 214, 216 by performing fisheye correction on the blocks 206, 208, 210. Furthermore, the stitching circuitry 304 of FIG. 3 processes the input tiles 212, 214, 216 to generate the stitched tiles 202 corresponding to the stitched image 204. In this example, at the tile-based encoding process 624, the stitched tiles 202 are provided directly to the respective processor cores of the encoding circuitry 310 of FIG. 3, where the encoding circuitry 310 encodes the stitched tiles 202 in parallel. This is because the stitched tiles are segmented based on the division information associated with the encoding process 624 implemented by the encoding circuitry 310, as described above. As such, the second stitching and encoding process 620 of FIG. 6B does not require copying of the stitched image 204 to separate pre-processing circuitry, thus reducing latency and/or computational load compared to the first stitching and encoding process 600 of FIG. 6A.

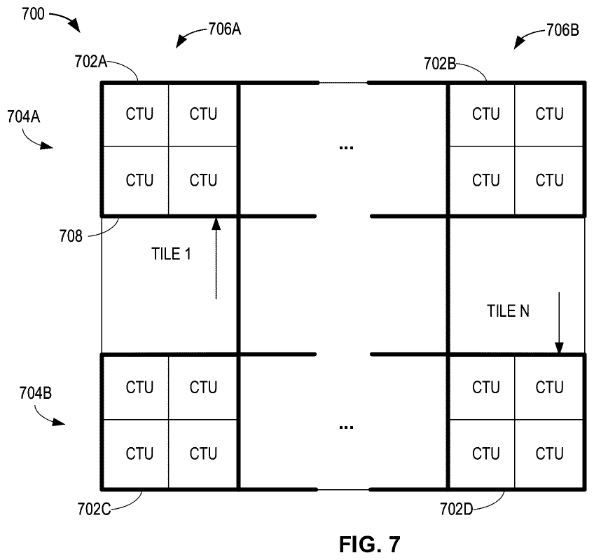

FIG. 7 illustrates example tile divisions 700 that may be generated by the image processing circuitry 102 of FIG. 3. In the illustrated example of FIG. 7, the tile divisions 700 include example tiles 702, where the tiles 702 include at least a first example tile 702A in an upper left corner of the tile divisions 700, a second example tile 702B in an upper right corner of the tile divisions 700, a third example tile 702C in a lower left corner of the tile divisions 700, and a fourth example tile 702D in a lower right corner of the tile divisions 700. While four of the tiles 702 are shown in the illustrated example of FIG. 7, the tile divisions 700 may include one or more additional tiles. In this example, the first and second tiles 702A, 702B correspond to a first example row 704A, and the third and fourth tiles 702C, 702D correspond to a second example row 704B. Furthermore, the first and third tiles 702A, 702C correspond to a first example column 706A, and the second and fourth tiles 702B, 702D correspond to a second example column 706B. In some examples, one or more additional rows of the tiles 702 may be implemented between the first and second rows 704A, 704B, and/or one or more additional columns of the tiles 702 may be implemented between the first and second columns 706A, 706B.

In the illustrated example of FIG. 7, each of the tiles 702 includes one or more example coding tree units (CTUs) 708. In some examples, the CTUs 708 correspond to a processing unit used in High Efficiency Video Coding (HEVC) applications. In some examples, a size of each of the CTUs 708 is 16-by-16 pixels. In other examples, the size of each of the CTUs 708 may be different (e.g., 32-by-32 pixels, 64-by-64 pixels, etc.). In this example, each of the tiles 702 includes four of the CTUs 708 arranged in a 2-by-2 square, where boundaries of the tiles 702 are aligned with corresponding boundaries of the CTUs 708. In other examples, a different number and/or arrangement of the CTUs 708 in each of the tiles 702 may be used instead (e.g., a 4-by-4 square, an 8-by-8 square, etc.).

In some examples, the image processing circuitry 102 selects dimensions of the tiles 702 and/or the CTUs 708 based on division information associated with an encoding process. For example, the division information identifies sizes of the tiles 702 and/or locations of the boundaries of the tiles 702 to be used in stitching and/or encoding of an image. In some examples, the division information is based on a number of processor cores, bandwidth of the processor cores, and/or input size requirements of the processor cores implemented by the stitching circuitry 304 and/or the encoding circuitry 310 of FIG. 3. In some examples, the tile generation circuitry 306 of FIG. 3 generates the blocks 206, 208, 210 of FIG. 2 by mapping the tile divisions 700 onto the fisheye images 110, 112, 114.

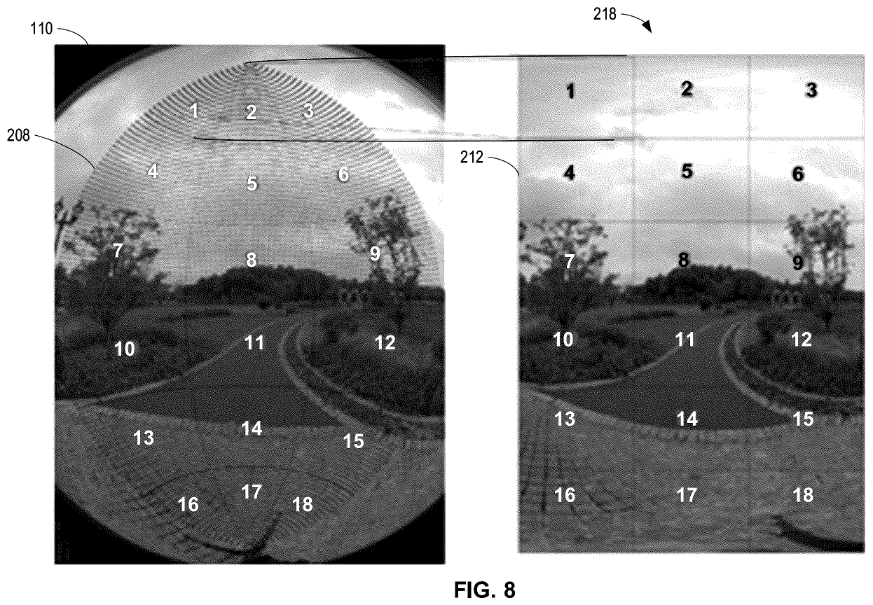

FIG. 8 illustrates the first example fisheye image 110 and the corresponding first example input image 218. In the illustrated example of FIG. 8, the tile generation circuitry 306 of FIG. 3 generates the first blocks 206 of the first fisheye image 110. In some examples, the tile generation circuitry 306 and/or the tile mapping circuitry 308 of FIG. 3 generates the first input tiles 212 of the first input image 218 by performing fisheye correction on the first blocks 206 to convert and/or transform the first blocks 206 from fisheye format to rectangular format. For example, the tile generation circuitry 306 and/or the tile mapping circuitry 308 maps each pixel location of the first blocks 206 to a corresponding pixel location in the first input tiles 212 based on example Equations 1, 2, 3, 4, 5, and/or 6 above. While the first fisheye image 110 and the first blocks 206 are shown in FIG. 8, the tile generation circuitry 306 can similarly generate the second blocks 208 and/or the second input tiles 214 of the second fisheye image 112 of FIG. 1, and/or the third blocks 210 and/or the third input tiles 216 of the third fisheye image 114 of FIG. 1.

In this example, the tile generation circuitry 306 assigns indices (e.g., numerical indices) to respective ones of the first blocks 208 and/or the first input tiles 212. In some examples, the tile generation circuitry 306 provides the indices to the stitching circuitry 304 and/or to the encoding circuitry 310 to enable identification of relative locations of the first blocks 208 in the first fisheye image 110. In some examples, the indices may be used by the stitching circuitry 304 and/or the encoding circuitry 310 to select respective processor cores for processing the input tiles 212. For example, the indices enable ones of the stitching processor cores of the stitching circuitry 304 to align and/or otherwise match with respective ones of the encoding processor cores of the encoding circuitry 310.

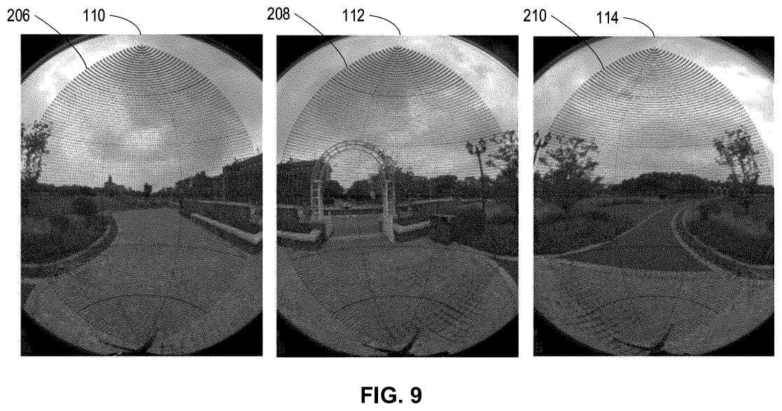

FIG. 9 illustrates the first, second, and third example fisheye images 110, 112, 114. In the illustrated example of FIG. 9, the first, second, and third blocks 206, 208, 210 are generated by the tile generation circuitry 306 of FIG. 3 and mapped onto the respective first, second, and third fisheye images 110, 112, 114. In some examples, the tile generation circuitry 306 generates and/or otherwise determines each of the first, second, and third blocks 206, 208, 210 based on the tile divisions 700 of FIG. 7.

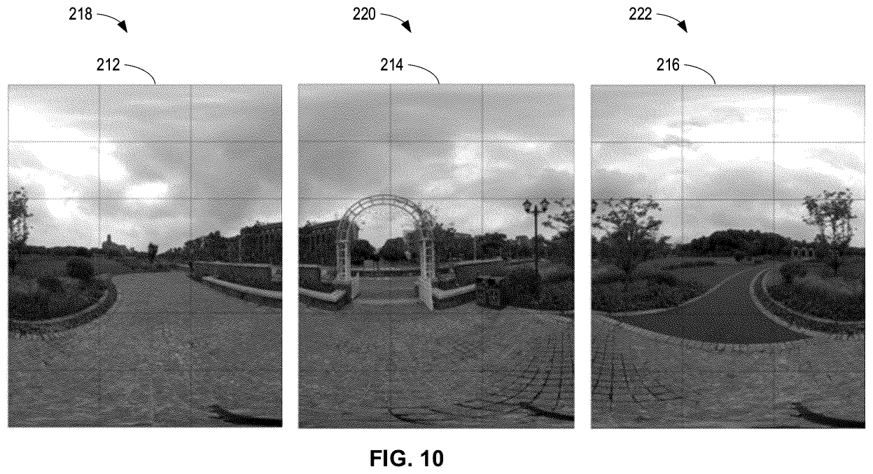

FIG. 10 illustrates the first, second, and third example input images 218, 220, 222 corresponding to the first, second, and third fisheye images 110, 112, 114, respectively, of FIG. 9. In the illustrated example of FIG. 10, the tile generation circuitry 306 of FIG. 3 outputs the first, second, and third input tiles 212, 214, 216 of the first, second, and third input images 218, 220, 222, respectively, in response to performing fisheye correction on the first, second, and third blocks 206, 208, 210 of FIG. 9. In some examples, the tile generation circuitry 306 stores the input tiles 212, 214, 216 in respective isolated memory blocks and provides the isolated memory blocks to the stitching circuitry 304 of FIG. 3.

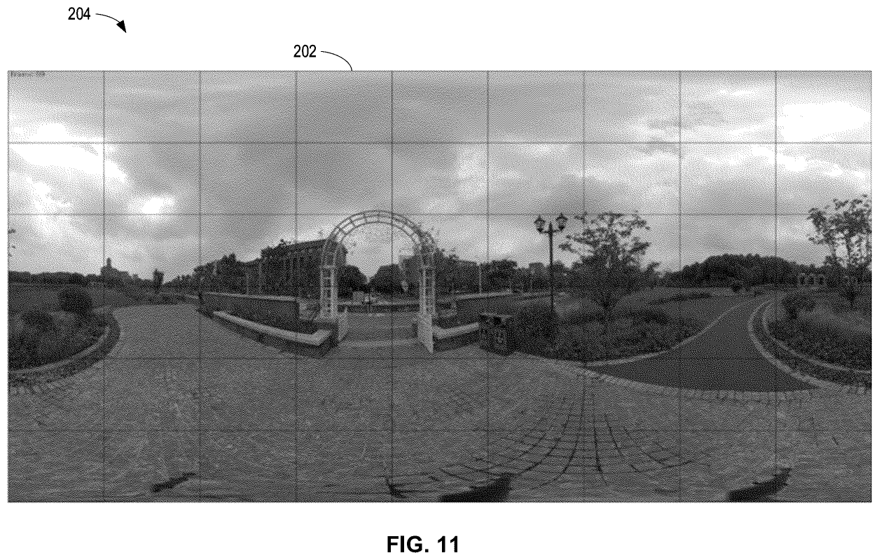

FIG. 11 illustrates the example stitched image 204 including the example stitched tiles 202. In the illustrated example of FIG. 11, the stitching circuitry 304 of FIG. 3 outputs the stitched tiles 202 in response to processing the input tiles 212, 214, 216 of FIG. 10 along separate stitching processor cores. For example, the stitching circuitry 304 blends and/or stitches ones of the input tiles 212, 214, 216 to generate corresponding ones of the stitched tiles 202. In some examples, the stitching circuitry 304 replaces ones of the input tiles 212, 214, 216 stored in isolated memory blocks with corresponding ones of the stitched tiles 202, and provides the isolated memory blocks including the stitched tiles 202 to the encoding circuitry 310 of FIG. 10. In some examples, the encoding circuitry 310 encodes the stitched tiles 202 with separate encoding processor cores. In some such examples, the encoding circuitry 310 can store encoded ones of the stitched tiles 202 in the database 312 of FIG. 3, and/or provide the encoded ones of the stitched tiles 202 to the client device 122 via the network 124 of FIG. 1. In some examples, the client device 122 can decode the stitched tiles 202 for use and/or display by the client device 122 in VR and/or AR applications.

While an example manner of implementing the image processing circuitry 102 of FIG. 1 is illustrated in FIG. 3, one or more of the elements, processes, and/or devices illustrated in FIG. 3 may be combined, divided, re-arranged, omitted, eliminated, and/or implemented in any other way. Further, the example input interface circuitry 302, the example stitching circuitry 304, the example tile generation circuitry 306, the example tile mapping circuitry 308, the example encoding circuitry 310, the example database 312, and/or, more generally, the example image processing circuitry 102 of FIG. 3, may be implemented by hardware, software, firmware, and/or any combination of hardware, software, and/or firmware. Thus, for example, any of the example input interface circuitry 302, the example stitching circuitry 304, the example tile generation circuitry 306, the example tile mapping circuitry 308, the example encoding circuitry 310, the example database 312, and/or, more generally, the example image processing circuitry 102, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example input interface circuitry 302, the example stitching circuitry 304, the example tile generation circuitry 306, the example tile mapping circuitry 308, the example encoding circuitry 310, and/or the example database 312 is/are hereby expressly defined to include a non-transitory computer readable storage device or storage disk such as a memory, a digital versatile disk (DVD), a compact disk (CD), a Blu-ray disk, etc., including the software and/or firmware. Further still, the example image processing circuitry 102 of FIG. 1 may include one or more elements, processes, and/or devices in addition to, or instead of, those illustrated in FIG. 3, and/or may include more than one of any or all of the illustrated elements, processes and devices.

A flowchart representative of example hardware logic circuitry, machine readable instructions, hardware implemented state machines, and/or any combination thereof for implementing the image processing circuitry 102 of FIG. 3 is shown in FIG. 13. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 14 and/or 15. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 12, many other methods of implementing the example image processing circuitry 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 12 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions and/or example operations 1200 that may be executed and/or instantiated by processor circuitry to implement the example image processing circuitry 102 of FIG. 3. The machine readable instructions and/or operations 1200 of FIG. 12 begin at block 1202, at which the image processing circuitry 102 obtains one or more of the example fisheye images 110, 112, 114 from the example cameras 104, 106, 108 of FIG. 1. For example, the example input interface circuitry 302 obtains the first fisheye image 110 from the first camera 104, the second fisheye image 112 from the second camera 106, and the third fisheye image 114 from the third camera 108. In some examples, the fisheye images 110, 112, 114 correspond to different portions of a 360-degree scene.

At block 1204, the example image processing circuitry 102 obtains the FOV information 406 of FIG. 4 from the client device 122 of FIG. 1. For example, the input interface circuitry 302 obtains the FOV information 406 from the client device 122 via the network 124 of FIG. 1, where the FOV information 406 indicates a position and/or orientation of a viewport of the client device 122.

At block 1206, the example image processing circuitry 102 determines the example tile divisions 700 of FIG. 7 based on division information and/or based on the FOV information 406. For example, the example tile generation circuitry 306 of FIG. 3 determines the tile divisions 700 based on the division information associated with the example encoding circuitry 310 of FIG. 3, where the processing parameters include, for example, a number of encoding processor cores implemented by the encoding circuitry 310.

At block 1208, the example image processing circuitry 102 maps the tile divisions 700 onto the fisheye images 110, 112, 114 to generate the example blocks 206, 208, 210 of FIG. 2. For example, the example tile mapping circuitry 308 of FIG. 3 generates the blocks 206, 208, 210 from the fisheye images 110, 112, 114 by mapping the tile divisions 700 thereupon using example Equations 1, 2, 3, 4, 5, and/or 6. In some examples, the tile mapping circuitry 308 maps the tile divisions 700 based on intrinsic and/or extrinsic parameters associated with the camera 104, 106, 108.

At block 1210, the example image processing circuitry 102 converts the blocks 206, 208, 210 from fisheye format to rectangular format to produce the example input tiles 212, 214, 216 of FIG. 2. In some examples, the tile generation circuitry 306 performs fisheye correction on ones of the blocks 206, 208, 210 to convert the blocks from the fisheye format to the rectangular format. In some examples, in response to performing the fisheye correction, the tile generation circuitry 306 outputs ones of the input tiles 212, 214, 216 and stores the input tiles 212, 214, 216 in isolated memory blocks.

At block 1212, the example image processing circuitry 102 stitches and/or blends the input tiles 212, 214, 216. For example, the example stitching circuitry 304 of FIG. 3 processes the input tiles 212, 214, 216 in separate stitching processor cores and/or threads to convert the input tiles 212, 214, 216 into corresponding ones of the stitched tiles 202 of FIG. 2. In some examples, the stitching circuitry 304 replaces ones of the input tiles 212, 214, 216 in respective ones of the isolated memory blocks with corresponding ones of the stitched tiles 202.

At block 1214, the example image processing circuitry 102 encodes the stitched tiles 202 in parallel. For example, the example encoding circuitry 310 of FIG. 3 operates on the stitched tiles 202 in the respective isolated memory blocks in separate encoding processor cores. In some examples, the encoding circuitry 310 encodes the stitched tiles 202 in parallel. In some examples, the encoding circuitry 310 stores encoded ones of the stitched tiles 202 in the example database 312 of FIG. 3 and/or provides the encoded ones of the stitched tiles 202 to the client device 122 via the network 124.

At block 1216, the example image processing circuitry 102 determines whether there are additional images to encode. For example, the input interface circuitry 302 determines whether additional images are provided from at least one of the cameras 104, 106, 108. In response to the input interface circuitry 302 determining that there are one or more additional images to encode (e.g., block 1216 returns a result of YES), control returns to block 1202. Alternatively, in response to the input interface circuitry 302 determining that there are no more additional images to encode (e.g., block 1216 returns a result of NO), control ends.

FIG. 13 is a block diagram of an example processor platform 1300 structured to execute and/or instantiate the machine readable instructions and/or operations of FIG. 12 to implement the image processing circuitry 102 of FIG. 3. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the example input interface circuitry 302, the example stitching circuitry 304, the example tile generation circuitry 306, the example tile mapping circuitry 308, and the example encoding circuitry 310.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a PCI interface, and/or a PCle interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1332, which may be implemented by the machine readable instructions of FIG. 12, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1312 of FIG. 13. In this example, the processor circuitry 1312 of FIG. 13 is implemented by a microprocessor 1400. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowchart of FIG. 12.

The cores 1402 may communicate by an example bus 1404. In some examples, the bus 1404 may implement a communication bus to effectuate communication associated with one(s) of the cores 1402. For example, the bus 1404 may implement at least one of an Inter-Integrated Circuit (12C) bus, a Serial Peripheral Interface (SPI) bus, a PCI bus, or a PCle bus. Additionally or alternatively, the bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and an example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The bus 1420 may implement at least one of an I2C bus, a SPI bus, a PCI bus, or a PCle bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1312 of FIG. 13. In this example, the processor circuitry 1312 is implemented by FPGA circuitry 1500. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowchart of FIG. 12 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowchart of FIG. 12. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the software represented by the flowchart of FIG. 12. As such, the FPGA circuitry 1500 may be structured to effectively instantiate some or all of the machine readable instructions of the flowchart of FIG. 12 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIG. 12 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware (e.g., external hardware circuitry) 1506. For example, the configuration circuitry 1504 may implement interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may implement the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and interconnections 1510 are configurable to instantiate one or more operations that may correspond to at least some of the machine readable instructions of FIG. 12 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowchart of FIG. 12 may be executed by one or more of the cores 1402 of FIG. 14 and a second portion of the machine readable instructions represented by the flowchart of FIG. 12 may be executed by the FPGA circuitry 1500 of FIG. 15.

In some examples, the processor circuitry 1312 of FIG. 13 may be in one or more packages. For example, the processor circuitry 1400 of FIG. 14 and/or the FPGA circuitry 1500 of FIG. 15 may be in one or more packages. In some examples, an XPU may be implemented by the processor circuitry 1312 of FIG. 13, which may be in one or more packages. For example, the XPU may include a CPU in one package, a DSP in another package, a GPU in yet another package, and an FPGA in still yet another package.

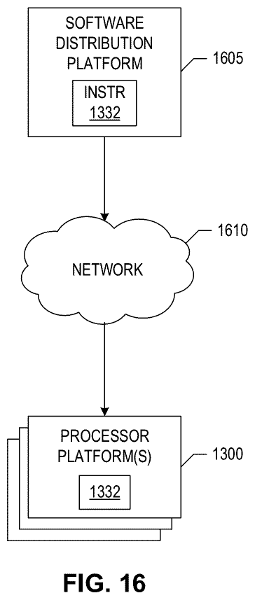

A block diagram illustrating an example software distribution platform 1605 to distribute software such as the example machine readable instructions 1332 of FIG. 13 to hardware devices owned and/or operated by third parties is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine readable instructions 1332, which may correspond to the example machine readable instructions 1200 of FIG. 12, as described above. The one or more servers of the example software distribution platform 1605 are in communication with a network 1610, which may correspond to any one or more of the Internet and/or the example network 124 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions 1200 of FIG. 12, may be downloaded to the example processor platform 1300, which is to execute the machine readable instructions 1332 to implement the image processing circuitry 102 of FIG. 3. In some example, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices.

From the foregoing, it will be appreciated that example systems, methods, apparatus, and articles of manufacture have been disclosed that perform tile-based stitching and encoding of images. Examples processor circuitry disclosed herein generates tiles from fisheye images based on tile division information associated with an encoding process. In examples disclosed herein, the tiles are stored in isolated memory blocks that are processed by separate processor cores in example stitching circuitry, and are then encoded in parallel by corresponding processor cores in example encoding circuitry. Accordingly, in examples disclosed herein, the operations of the stitching circuitry and the encoding circuitry are aligned on the same tiles, thus enabling reuse of the isolated memory blocks therebetween. The disclosed systems, methods, apparatus, and articles of manufacture improve the efficiency of using a computing device by reducing the need for additional pre-processing of image data between a stitching process and an encoding process, thus increasing processing speed and reducing inefficiencies caused by redundant operations. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for tile-based stitching and encoding of images are disclosed herein. Further examples and combinations thereof include the following.

Example 1 includes an apparatus to stitch and encode images, the apparatus comprising tile generation circuitry to generate first input tiles from a first image and second input tiles from a second image, the first image from a first camera and the second image from a second camera, stitching circuitry to process the first input tiles and the second input tiles to convert the first input tiles into corresponding first stitched tiles and to convert the second input tiles into corresponding second stitched tiles, and encoding circuitry to encode the first stitched tiles and the second stitched tiles in parallel, wherein the tile generation circuitry is to generate the first input tiles and the second input tiles based on division information associated with the encoding circuitry.

Example 2 includes the apparatus of example 1, wherein the first image and the second image are in a fisheye format and the first input tiles and the second input tiles are in a rectangular format.

Example 3 includes the apparatus of example 2, wherein the tile generation circuitry further includes tile mapping circuitry to map blocks of the first image in the fisheye format to corresponding ones of the first input tiles in the rectangular format, and map blocks of the second image in the fisheye format to corresponding ones of the second input tiles in the rectangular format.

Example 4 includes the apparatus of example 1, wherein the encoding circuitry is to encode ones of the first stitched tiles and ones of the second stitched tiles in separate processor cores.

Example 5 includes the apparatus of example 1, wherein the division information includes at least one of a number of processor cores used in an encoding process or input size requirements associated with the encoding process, and the tile generation circuitry is to generate the first input tiles and the second input tiles further based on parameters of the first camera and the second camera.

Example 6 includes the apparatus of example 5, wherein the tile generation circuitry is to generate the first input tiles and the second input tiles further based on a field of view associated with a client device.

Example 7 includes the apparatus of example 1, further including at least one memory, wherein the tile generation circuitry is to (i) store ones of the first input tiles in respective first isolated memory blocks of the at least one memory, and (ii) store ones of the second input tiles in respective second isolated memory blocks of the at least one memory, and the stitching circuitry is to (i) replace the ones of the first input tiles in the respective first isolated memory blocks with corresponding ones of the first stitched tiles, and (ii) replace the ones of the second input tiles in the respective second isolated memory blocks with corresponding ones of the second stitched tiles.

Example 8 includes the apparatus of example 7, wherein the encoding circuitry is to operate on the respective first isolated memory blocks and the respective second isolated memory blocks in parallel.

Example 9 includes At least one non-transitory computer readable medium comprising instructions that, when executed, cause processor circuitry to at least generate first input tiles from a first image and second input tiles from a second image, the first image from a first camera and the second image from a second camera, process the first input tiles and the second input tiles to convert the first input tiles into corresponding first stitched tiles and to convert the second input tiles into corresponding second stitched tiles, and execute an encoding process to encode the first stitched tiles and the second stitched tiles in parallel, the first input tiles and the second input tiles to be generated based on division information associated with the encoding process.

Example 10 includes the at least one non-transitory computer readable medium of example 9, wherein the first image and the second image are in a fisheye format and the first input tiles and the second input tiles are in a rectangular format.

Example 11 includes the at least one non-transitory computer readable medium of example 10, wherein the instructions cause the processor circuitry to map blocks of the first image in the fisheye format to corresponding ones of the first input tiles in the rectangular format, and map blocks of the second image in the fisheye format to corresponding ones of the second input tiles in the rectangular format.

Example 12 includes the at least one non-transitory computer readable medium of example 9, wherein the instructions cause the processor circuitry to encode ones of the first stitched tiles and ones of the second stitched tiles in separate processor cores.

Example 13 includes the at least one non-transitory computer readable medium of example 9, wherein the division information includes at least one of a number of processor cores used in the encoding process or input size requirements associated with the encoding process, and the instructions cause the processor circuitry to generate the first input tiles and the second input tiles further based on parameters of the first camera and the second camera.

Example 14 includes the at least one non-transitory computer readable medium of example 13, wherein the instructions cause the processor circuitry to generate the first input tiles and the second input tiles further based on a field of view associated with a client device.

Example 15 includes the at least one non-transitory computer readable medium of example 9, wherein the instructions cause the processor circuitry to (i) store ones of the first input tiles in respective first isolated memory blocks of at least one memory, and (ii) store ones of the second input tiles in respective second isolated memory blocks of the at least one memory, (iii) replace the ones of the first input tiles in the respective first isolated memory blocks with corresponding ones of the first stitched tiles, and (iv) replace the ones of the second input tiles in the respective second isolated memory blocks with corresponding ones of the second stitched tiles.

Example 16 includes the at least one non-transitory computer readable medium of example 15, wherein the instructions cause the processor circuitry to operate on the respective first isolated memory blocks and the respective second isolated memory blocks in parallel.

Example 17 includes an apparatus to stitch and encode images, the apparatus comprising at least one memory, instructions stored in the apparatus, and processor circuitry to execute the instructions to at least generate first input tiles from a first image and second input tiles from a second image, the first image from a first camera and the second image from a second camera, process the first input tiles and the second input tiles to convert the first input tiles into corresponding first stitched tiles and to convert the second input tiles into corresponding second stitched tiles, and execute an encoding process to encode the first stitched tiles and the second stitched tiles in parallel, the first input tiles and the second input tiles to be generated based on division information associated with the encoding process.

Example 18 includes the apparatus of example 17, wherein the first image and the second image are in a fisheye format and the first input tiles and the second input tiles are in a rectangular format.

Example 19 includes the apparatus of example 18, wherein the processor circuitry is to map blocks of the first image in the fisheye format to corresponding ones of the first input tiles in the rectangular format, and map blocks of the second image in the fisheye format to corresponding ones of the second input tiles in the rectangular format.

Example 20 includes the apparatus of example 17, wherein the processor circuitry is to encode ones of the first stitched tiles and ones of the second stitched tiles in separate processor cores.

Example 21 includes the apparatus of example 17, wherein the division information includes at least one of a number of processor cores used in the encoding process or input size requirements associated with the encoding process, and the processor circuitry is to generate the first input tiles and the second input tiles further based on parameters of the first camera and the second camera.

Example 22 includes the apparatus of example 21, wherein the processor circuitry is to generate the first input tiles and the second input tiles further based on a field of view associated with a client device.

Example 23 includes the apparatus of example 17, wherein the processor circuitry is to (i) store ones of the first input tiles in respective first isolated memory blocks of the at least one memory, and (ii) store ones of the second input tiles in respective second isolated memory blocks of the at least one memory, (iii) replace the ones of the first input tiles in the respective first isolated memory blocks with corresponding ones of the first stitched tiles, and (iv) replace the ones of the second input tiles in the respective second isolated memory blocks with corresponding ones of the second stitched tiles.

Example 24 includes the apparatus of example 23, wherein the processor circuitry is to operate on the respective first isolated memory blocks and the respective second isolated memory blocks in parallel.

Example 25 includes an apparatus to stitch and encode images, the apparatus comprising means for generating tiles to generate first input tiles from a first image and second input tiles from a second image, the first image from a first camera and the second image from a second camera, means for stitching to process the first input tiles and the second input tiles to convert the first input tiles into corresponding first stitched tiles and to convert the second input tiles into corresponding second stitched tiles, and means for encoding to encode the first stitched tiles and the second stitched tiles in parallel, wherein the means for generating tiles is to generate the first input tiles and the second input tiles based on division information associated with the means for encoding.

Example 26 includes the apparatus of example 25, wherein the first image and the second image are in a fisheye format and the first input tiles and the second input tiles are in a rectangular format.

Example 27 includes the apparatus of example 26, wherein the means for generating tiles further includes means for mapping to map blocks of the first image in the fisheye format to corresponding ones of the first input tiles in the rectangular format, and map blocks of the second image in the fisheye format to corresponding ones of the second input tiles in the rectangular format.

Example 28 includes the apparatus of example 25, wherein the means for encoding is to encode ones of the first stitched tiles and ones of the second stitched tiles in separate processor cores.

Example 29 includes the apparatus of example 25, wherein the division information includes at least one of a number of processor cores used in an encoding process or input size requirements associated with the encoding process, and the means for generating tiles is to generate the first input tiles and the second input tiles further based on parameters of the first camera and the second camera.

Example 30 includes the apparatus of example 29, wherein the means for generating tiles is to generate the first input tiles and the second input tiles further based on a field of view associated with a client device.

Example 31 includes the apparatus of example 25, further including at least one memory, wherein the means for generating tiles is to (i) store ones of the first input tiles in respective first isolated memory blocks of the at least one memory, and (ii) store ones of the second input tiles in respective second isolated memory blocks of the at least one memory, and the means for stitching is to (i) replace the ones of the first input tiles in the respective first isolated memory blocks with corresponding ones of the first stitched tiles, and (ii) replace the ones of the second input tiles in the respective second isolated memory blocks with corresponding ones of the second stitched tiles.

Example 32 includes the apparatus of example 31, wherein the means for encoding is to operate on the respective first isolated memory blocks and the respective second isolated memory blocks in parallel.

Example 33 includes a method to stitch and encode images, the method comprising generating first input tiles from a first image and second input tiles from a second image, the first image from a first camera and the second image from a second camera, processing the first input tiles and the second input tiles to convert the first input tiles into corresponding first stitched tiles and to convert the second input tiles into corresponding second stitched tiles, and executing an encoding process to encode the first stitched tiles and the second stitched tiles in parallel, the first input tiles and the second input tiles to be generated based on division information associated with the encoding process.

Example 34 includes the method of example 33, wherein the first image and the second image are in a fisheye format and the first input tiles and the second input tiles are in a rectangular format.

Example 35 includes the method of example 34, further including mapping blocks of the first image in the fisheye format to corresponding ones of the first input tiles in the rectangular format, and mapping blocks of the second image in the fisheye format to corresponding ones of the second input tiles in the rectangular format.

Example 36 includes the method of example 33, further including encoding ones of the first stitched tiles and ones of the second stitched tiles in separate processor cores.

Example 37 includes the method of example 33, wherein the division information includes at least one of a number of processor cores used in the encoding process or input size requirements associated with the encoding process, and further including generating the first input tiles and the second input tiles further based on parameters of the first camera and the second camera.

Example 38 includes the method of example 37, further including generating the first input tiles and the second input tiles further based on a field of view associated with a client device.

Example 39 includes the method of example 33, further including (i) storing ones of the first input tiles in respective first isolated memory blocks of the at least one memory, (ii) storing ones of the second input tiles in respective second isolated memory blocks of the at least one memory, (iii) replacing the ones of the first input tiles in the respective first isolated memory blocks with corresponding ones of the first stitched tiles, and (iv) replacing the ones of the second input tiles in the respective second isolated memory blocks with corresponding ones of the second stitched tiles.

Example 40 includes the method of example 39, further including operating on the respective first isolated memory blocks and the respective second isolated memory blocks in parallel.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus to stitch and encode images, the apparatus comprising:
tile generation circuitry to generate first input tiles from a first image and second input tiles from a second image, the first image from a first camera and the second image from a second camera;
stitching circuitry to process the first input tiles and the second input tiles to convert the first input tiles into corresponding first stitched tiles and to convert the second input tiles into corresponding second stitched tiles; and
encoding circuitry to encode the first stitched tiles and the second stitched tiles in parallel, wherein the tile generation circuitry is to generate the first input tiles and the second input tiles based on division information associated with the encoding circuitry.

2. The apparatus of claim 1, wherein the first image and the second image are in a fisheye format and the first input tiles and the second input tiles are in a rectangular format.

3. The apparatus of claim 2, wherein the tile generation circuitry further includes tile mapping circuitry to:
map blocks of the first image in the fisheye format to corresponding ones of the first input tiles in the rectangular format; and
map blocks of the second image in the fisheye format to corresponding ones of the second input tiles in the rectangular format.

4. The apparatus of claim 1, wherein the encoding circuitry is to encode ones of the first stitched tiles and ones of the second stitched tiles in separate processor cores.

5. The apparatus of claim 1, wherein the division information includes at least one of a number of processor cores used in an encoding process or input size requirements associated with the encoding process, and the tile generation circuitry is to generate the first input tiles and the second input tiles further based on parameters of the first camera and the second camera.

6. The apparatus of claim 5, wherein the tile generation circuitry is to generate the first input tiles and the second input tiles further based on a field of view associated with a client device.

7. The apparatus of claim 1, further including at least one memory, wherein the tile generation circuitry is to (i) store ones of the first input tiles in respective first isolated memory blocks of the at least one memory, and (ii) store ones of the second input tiles in respective second isolated memory blocks of the at least one memory, and the stitching circuitry is to (i) replace the ones of the first input tiles in the respective first isolated memory blocks with corresponding ones of the first stitched tiles, and (ii) replace the ones of the second input tiles in the respective second isolated memory blocks with corresponding ones of the second stitched tiles.

8. The apparatus of claim 7, wherein the encoding circuitry is to operate on the respective first isolated memory blocks and the respective second isolated memory blocks in parallel

9. At least one non-transitory computer readable medium comprising instructions that, when executed, cause processor circuitry to at least:
generate first input tiles from a first image and second input tiles from a second image, the first image from a first camera and the second image from a second camera;
process the first input tiles and the second input tiles to convert the first input tiles into corresponding first stitched tiles and to convert the second input tiles into corresponding second stitched tiles; and
execute an encoding process to encode the first stitched tiles and the second stitched tiles in parallel, the first input tiles and the second input tiles to be generated based on division information associated with the encoding process.

10. The at least one non-transitory computer readable medium of claim 9, wherein the first image and the second image are in a fisheye format and the first input tiles and the second input tiles are in a rectangular format.

11. The at least one non-transitory computer readable medium of claim 10, wherein the instructions cause the processor circuitry to:
map blocks of the first image in the fisheye format to corresponding ones of the first input tiles in the rectangular format; and
map blocks of the second image in the fisheye format to corresponding ones of the second input tiles in the rectangular format.

12. The at least one non-transitory computer readable medium of claim 9, wherein the instructions cause the processor circuitry to encode ones of the first stitched tiles and ones of the second stitched tiles in separate processor cores.

13. The at least one non-transitory computer readable medium of claim 9, wherein the division information includes at least one of a number of processor cores used in the encoding process or input size requirements associated with the encoding process, and the instructions cause the processor circuitry to generate the first input tiles and the second input tiles further based on parameters of the first camera and the second camera.

14. The at least one non-transitory computer readable medium of claim 13, wherein the instructions cause the processor circuitry to generate the first input tiles and the second input tiles further based on a field of view associated with a client device.

15. The at least one non-transitory computer readable medium of claim 9, wherein the instructions cause the processor circuitry to (i) store ones of the first input tiles in respective first isolated memory blocks of at least one memory, and (ii) store ones of the second input tiles in respective second isolated memory blocks of the at least one memory, (iii) replace the ones of the first input tiles in the respective first isolated memory blocks with corresponding ones of the first stitched tiles, and (iv) replace the ones of the second input tiles in the respective second isolated memory blocks with corresponding ones of the second stitched tiles.

16. The at least one non-transitory computer readable medium of claim 15, wherein the instructions cause the processor circuitry to operate on the respective first isolated memory blocks and the respective second isolated memory blocks in parallel.

17. An apparatus to stitch and encode images, the apparatus comprising:
at least one memory;
instructions stored in the apparatus; and
processor circuitry to execute the instructions to at least:
generate first input tiles from a first image and second input tiles from a second image, the first image from a first camera and the second image from a second camera;
process the first input tiles and the second input tiles to convert the first input tiles into corresponding first stitched tiles and to convert the second input tiles into corresponding second stitched tiles; and
execute an encoding process to encode the first stitched tiles and the second stitched tiles in parallel, the first input tiles and the second input tiles to be generated based on division information associated with the encoding process.

18. The apparatus of claim 17, wherein the first image and the second image are in a fisheye format and the first input tiles and the second input tiles are in a rectangular format.

19. The apparatus of claim 18, wherein the processor circuitry is to:
map blocks of the first image in the fisheye format to corresponding ones of the first input tiles in the rectangular format; and
map blocks of the second image in the fisheye format to corresponding ones of the second input tiles in the rectangular format.

20. The apparatus of claim 17, wherein the processor circuitry is to encode ones of the first stitched tiles and ones of the second stitched tiles in separate processor cores.

21-40. (canceled)
